(19) United States
(12) Patent Application Publication
(10) Pub. No.: US 2007/0013331 A1
(43) Pub. Date: Jan. 18, 2007

(54) Adjustment system for a motor vehicle

(76) Inventor: Roland Kalb, Rossach (DE)

Correspondence Address: WHITE & CASE LLP;PATENT DEPARTMENT, 1155 AVENUE OF THE AMERICAS, NEW YORK, NY, 10036, US

(21) Appl. No.: 11/486,815

(22) Filed: Jul. 13, 2006

(30) Foreign Application Priority Data
Jul. 15, 2005 (DE) 20 2005 011 333.6

(51) Int. Cl. H02P 7/06

(52) U.S. Cl. 318/254

(57) ABSTRACT

Adjustment system for a motor vehicle, having a mechanically commutated drive motor and a control apparatus, in which the clontrol apparatus has means for measuring a ripple of a drive current through the mechanically commutated drive motor caused by the mechanical commutation, the control apparatus designed to control the drive motor depending on the measured ripple, and slots in a rotor of the mechanically commutated drive motor being skewed.

The invention relates to an adjustment system for a motor vehicle.

### BACKGROUND OF THE INVENTION

Adjustment systems in motor vehicles are required, for example, to adjust the position of a seat pan or a window in a motor vehicle. Methods for controlling an adjustment system with a mechanically commutated DC motor are disclosed, for example, in EP 0 689 054 A1, EP 0 730 156 A1 and DE 39 35 585 A1.

An AC component of the current of DC motors, which is also described as ripple, can be monitored and evaluated for determining a rotational position or a rotational speed of the motor. A so-called zero crossing method is described in DE 35 27 906 A1, for example, in which the zero crossings of the current are detected after elimination of the DC component.

### SUMMARY OF THE INVENTION

The invention is based on the object of further developing an adjustment system for a motor vehicle by evaluating the drive current.

This object is achieved by means of an adjustment system with the characteristics of the independent claims. Advantageous improvements are the subject matter of dependent claims.

As a result, an adjustment system for a motor vehicle with a mechanically commutated drive motor and a control apparatus is provided. A mechanically commutated drive motor preferably has a commutator with commutator segments, on which advantageously two sliding brushes are arranged. The control apparatus has means, in particular an electrical circuit, for measuring a ripple of a drive current caused by the mechanical commutation. These means preferably have a measuring resistor, an analog/digital converter and an arithmetic and logic unit, wherein the analog/digital converter and the arithmetic and logic unit can be integrated within a microcontroller. This drive current flows through the mechanically commutated drive motor. Its ripple is particularly dependent on a winding pitch of existing motor coils and on the number of slots of the mechanically commutated drive motor.

Furthermore, the control apparatus is designed to control the drive motor depending on the measured ripple. Advantageously, the ripples are counted by the control apparatus and an adjustment position determined from this count evaluation. Depending on this determination, the drive current is controlled by the control apparatus by the fact that the control apparatus preferably has a power switch, for example a relay or a power semiconductor, and controls this power switch depending on the determination of the adjustment position.

The mechanically commutated drive motor has a number of turns of a coil with a winding pitch, the winding pitch being calculated by halving the number of slots of the mechanically commutated drive motor and subtracting the number 2 from the halved value. Hence
Winding pitch=(Number of slots/2)−2

Here, the number of turns can define one turn, advantageously half of all the turns, or preferably all the turns. At the same time, this number of turns can refer to one, several, or advantageously every coil. The winding pitch specifies a number of pole cores encompassed by the coil.

A mechanically commutated drive motor with the following design is used as a starting point. An armature current of the drive current branches out after the brushes. Two sides of a coil of a lap winding are connected together by means of end windings outside a laminated armature core and thus form an overall coil. On one side of the commutator, the end windings have extensions (lugs), which are soldered, for example, into the commutator segments that are insulated from one another. Carbon brushes fixed to brush holders slide on these extensions.

One embodiment provides for a mechanically commutated drive motor, which has a total of ten slots and wherein the number of turns has a winding pitch of three.

Another way of achieving the object according to the invention provides for an adjustment system for a motor vehicle which has a mechanically commutated drive motor and a control apparatus. The control apparatus has means, in particular an electrical circuit, for measuring a ripple of a drive current caused by the mechanical commutation. This drive current flows through the mechanically commutated drive motor. Its ripple is particularly dependent on a winding pitch of existing motor coils and on the number of slots of the mechanically commutated drive motor.

Furthermore, the control apparatus is designed to control the drive motor depending on the measured ripple. Advantageously, the ripples are counted by the control apparatus and an adjustment position determined from this count evaluation. Advantageously, the ripple is also monitored with respect to time and evaluated in order to determine a speed, in particular by determining the time interval between two or more consecutive ripples. The drive current is controlled by the control apparatus depending on the determination of the position and/or speed.

One turn of a coil of the mechanically commutated drive motor has a winding pitch that is different than at least one other turn. In this case, the other turn can be part of the same coil or of another coil of the mechanically commutated drive motor. In particular, the mechanically commutated drive motor has a coil with at least two turns with different winding pitches. Alternatively or in combination, the mechanically commutated drive motor can also have different winding pitches in different coils. Advantageously, therefore, at least two coils of a mechanically commutated motor are in this case wound using two different winding pitches. According to one advantageous embodiment, each coil of the motor has the at least two turns with different winding pitches.

In one advantageous improvement, it is arranged that the turns with the different winding pitches produce a characteristic signal of the ripple that is associated with one motor revolution or an angle of motor revolution. The characteristic signal can be, for example a significant amplitude value or a significant amplitude profile of the ripple depending on the angle of rotation of the drive motor.

In this improvement, the control apparatus is designed to detect the characteristic signal and to correct an adjustment position and/or an adjustment speed of a part to be adjusted depending on the detection. Here, the correction can preferably be carried out based on a pattern detection, the position and/or speed being corrected depending on the pattern recognized within the ripple.

Another way of achieving the object according to the invention is an adjustment system for a motor vehicle with a mechanically commutated drive motor and a control apparatus. The control apparatus has means, in particular an electrical circuit, for measuring a ripple of a drive current caused by the mechanical commutation. This drive current flows through the mechanically commutated drive motor. Its ripple is particularly dependent on a winding pitch of existing motor coils and on the number of slots of the mechanically commutated drive motor.

Furthermore, the control apparatus is designed to control the drive motor depending on the measured ripple. Advantageously, the ripples are counted by the control apparatus and an adjustment position and/or an adjustment speed is determined from this count evaluation. The drive current is controlled by the control apparatus depending on this determination.

The mechanically commutated drive motor has a rotor, the slots of which are skewed in the laminated core. At the same time, a motor armature of the mechanically commutated drive motor is slotted at an angle to the axis of the motor shaft in at least some areas. In doing so, the skewing can advantageously be restricted to an axial area, in particular to at least half the length of the slots.

The three solutions mentioned above can preferably be combined in improvements to achieve a characteristic ripple in order to maximize its amplitude. For example, a mechanically commutated drive motor of this kind has ten slots, on which turns of coils with a winding pitch of three are wound. Two turns of two opposite coils with respect to the motor axis additionally have a winding pitch of two. At the same time, the ten rotor slots are used at an angle (skewed).

In one advantageous embodiment, it is arranged that the mechanically commutated drive motor is skewed with eight slots and has coils with a winding pitch of three. By way of example, each coil of the mechanically commutated drive motor has a number of turns of at least fourteen.

Advantageously, the control apparatus is set up to determine a position and/or an adjustment speed of a part to be adjusted depending on the measured ripple. In addition, it is preferably arranged that the control apparatus is also set up to detect a collision between the part to be adjusted and an object or a part of the body. This collision detection is also known as excessive force limitation or an anti-trapping system.

An adjustment system for a motor vehicle described above is advantageously designed for adjusting a window, an adjustable part of a seat, a swing door, a sliding door, a trunk lid or a tailgate.

### BRIEF DESCRIPTION OF THE DRAWINGS

The invention is described in more detail below in exemplary embodiments with reference to graphical illustrations. Here:

FIG. 1 shows a drive mechanism with an electronic control apparatus for an adjustment device for a motor vehicle,

FIG. 2 shows a schematic diagram of a development of an electric motor over 360°,

FIG. 3 shows a schematic plan view of one face of a rotor of a bar-wound armature motor with three turns of a coil with a winding pitch of three,

FIG. 4 shows a schematic plan view of one face of a rotor of a bar armature motor with three turns of a coil with a winding pitch of three and two turns of a coil with a winding pitch of four,

FIG. 5 shows a motor armature with straight slots, and

FIG. 6 shows a motor armature with angled slots.

### DETAILED DESCRIPTION

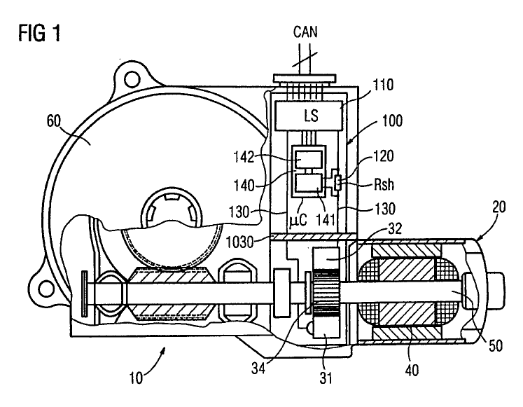

FIG. 1 shows a drive mechanism 10 with a bar armature motor 20, which is connected by means of two conductors 130 to a control apparatus 100 for controlling a drive movement and for evaluating a drive movement of the bar armature motor 20. The drive 10 of the exemplary embodiment in FIG. 1 also has a gear housing 60 in which gearing is arranged. The bar armature motor 20 has a schematically shown coil laminated core 40, which is firmly attached to a motor shaft 50. The bar armature motor 20 is a mechanically commutated electric motor, which has a commutator 34 and two brushes 31 and 32. These brushes can advantageously be designed as hammer brushes 31, 32.

The brushes 31 and 32 are each connected to the control apparatus 100 by means of an electrical conductor 130 and a plug 1030. Current is supplied to the bar armature motor 20 for controlling the drive movement via these electrical conductors 130. A power switch 110, which in the exemplary embodiment of FIG. 1 is connected via a measuring resistor (shunt resistor Rsh) 120 to the electrical conductors 130, is used for controlling a drive current. The power switch 110 is a relay, for example. Alternatively, a power semiconductor bridge can also be used for the power switch 110 so that the motor current can also be controlled by means of a pulse width modulated signal.

For control purposes, the power switch 110 is connected to an electronic control unit 140. The electronic control unit 140 is advantageously integrated on a semiconductor chip. This can be designed, for example, as a microcontroller μC or an application-specific integrated circuit (ASIC) in which an arithmetic and logic unit 142 and an analog/digital converter 141 are integrated. The analog/digital converter 141 is connected to the measuring resistor (shunt resistor Rsh) 120 for measuring the voltage drop across the measuring resistor 120. In addition, the voltage on the motor 20 can be determined by the analog/digital converter 141 shown, or by a further analog/digital converter.

Here, the control apparatus 100 is designed to determine a ripple of the drive current. For this purpose, the voltage drop across the measuring resistor 120 is sensed with a higher resolution than the frequency of the ripple. At the same time, the ripple of the drive current corresponds to the commutation of the electric motor 20, wherein a number of ripples per revolution of the shaft 50 of the electric motor 20 depends on a number of segments of the commutator 34. From this physical and technical correlation in particular, a position and/or position change and/or an adjustment speed can therefore be determined by the control apparatus 100 from the drive current ripple. The drive movement of the drive 10 effected by the electric motor 20 is controlled by the control apparatus 100 by means of the power switch 110 depending on the determined position and/or the determined position change and/or the determined adjustment speed.

The control and measurement data can be transmitted via a CAN bus connection. The control apparatus 100 can also receive measurement-related or control-related parameters for programming via this CAN interface. For example, information relating to a structural design, in particular winding pitch, number of slots etc., can be transmitted via the CAN bus connection.

The amplitude of the ripple depends on structural and electromagnetic characteristics of the electric motor 20. The electric motor 20 is designed for at least a significant amplitude of ripple.

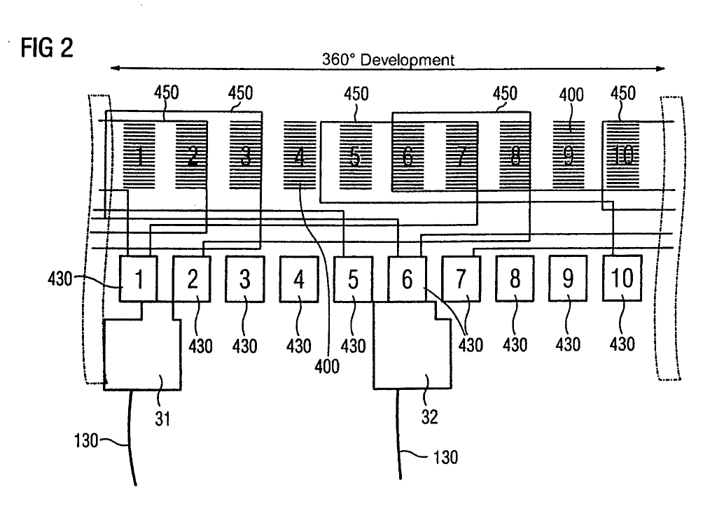

The electric motor 20 is shown schematically in a 360° development in FIG. 2. The two brushes 31 and 32 are again connected to cables 130 to supply the current. Here, the two brushes slide on ten (1 . . . 10) segments 430 of the commutator 34. Depending on the angular position of the motor 20, two segments 430 are short-circuited or not short-circuited by one of the brushes 31, 32). Owing to the change between short-circuited and non-short-circuited segments 430 with the rotational movement of the motor 20, the turns 450 of coils that are electrically connected to the respective segments are also short-circuited or not short-circuited accordingly. This causes a change in the resulting impedance of the motor 20 depending on the rotational angle of the motor 20. The amplitude of the ripple of the drive current is in turn dependent on this change in impedance.

In the exemplary embodiment of FIG. 2, a ten-slot electric motor 20 is used. Here, the motor 20 has a winding pitch of three, as three iron pole cores 400 are encompassed in each case by one coil turn 450. Due to the small number, three, of iron pole cores encompassed, the amplitude of the ripple is significantly pronounced. For a simplified representation, only one turn 450 is shown for each coil. However, a number of turns corresponding to the required motor power is required to design an electric motor 20 with adequate torque. Furthermore, for simplification, only four coils each with one turn 450 are shown.

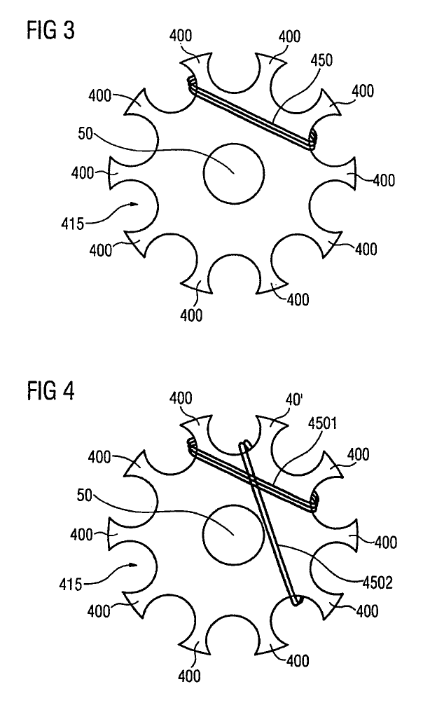

FIG. 3 shows a schematic plan view of one face of a ten-slot motor armature with ten iron pole cores 400, which are fixed to the motor shaft 50. Three turns 450 of one coil are also shown, which have a winding pitch of three.

A further exemplary embodiment with a plan view of one face of the motor armature is shown schematically in FIG. 4. Three turns 4501 of one coil have a winding pitch of three, while two other turns 4502 of one coil have a winding pitch of four. In this case, the three turns 4501 and the two turns 4502 are part of one or two coils.

This division into turns 4501, 4502 with different winding pitches can be provided for one, several or for all coils. In doing so, this difference in winding pitch causes a characteristic in the ripple of the drive current, which can be evaluated by the control apparatus 100. Naturally, contrary to the diagrams in FIGS. 3 and 4, a large number of turns are required, which are not shown in FIGS. 3 and 4 purely for reasons of better clarity.

A rotor 4 of the electric motor 20 with straight slots in the laminated core for accommodating the coils is shown schematically in FIG. 5. Iron pole cores 411 are fixed to the motor shaft 50. The coils, which are wound around the iron pole cores 411 and are arranged in the slots 414, are not shown in FIG. 5. In FIG. 5, the iron pole cores 411 are arranged parallel to the motor shaft 50. The motor armature therefore has straight slots.

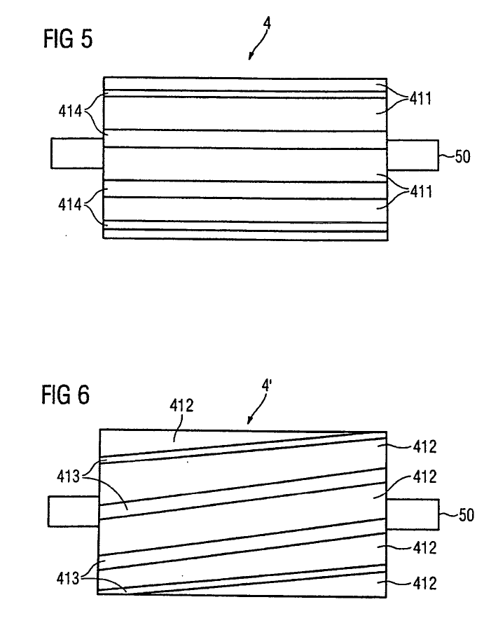

Another variation of an embodiment to adapt the electric motor 20 to form a significant ripple amplitude is shown schematically in FIG. 6 as rotor 4′. In FIG. 6, the slots 413 of the laminated core for accommodating the coils are skewed. The iron pole cores 412 are again fixed to the shaft 50. The skewing shown causes a reduction in the torque ripple of the electric motor.

The torque M(α) of a coil can be defined as:
M_{(α)}=w·Lₘ·R_{A}·I(Bn(α+s)−Bn(α))
with
M(α) as the torque contribution of the respective motor coil dependent on the angle α,
α as the angle between the magnetic field of the motor and the motor coil currently under consideration,
w as the number of turns of a particular coil,
Lₘ as the length of the conductor of a particular coil,
R_{A} as a coil radius,
Bn as the normal induction,
I as the coil current,
S as the angle of the winding pitch.

The induced voltage e(α) of a coil (SPi) can therefore be given by:
e(α)=−w·Lₘ·v(Bn(α+s)−Bn(α))
with
e(α) as the induced voltage for each coil (SPi) and
v as the rotational speed of the motor.

Consequently, both the torque M(α) and also the induced voltage e(α) are dependent on the angle of the winding pitch S. For a winding pitch of 3, the angle of the winding pitch is 108°, for example, while for a winding pitch of 4, the angle of the winding pitch is 144°.

Not taken into account here are the geometries of the commutator, i.e. the width of the respective brush and their positions with respect to one another, and the shape and spacing of the commutator segments, which, depending on the rotation angle, have an effect on the induced voltage and the torque. Furthermore, this effect can change over the life of the motor. Taking into account this simplification, the current, which includes both the DC component and the ripple, can be given by:

$${I}_{tot} ( α ) = \frac{{U}_{Kl} - \sum {e}_{SPi} ( α )}{Ri ( α )}$$

with
Iₜₒₜ(α) as the instantaneous current flow through the motor,
U_{Kl} as a terminal voltage applied to the motor, and
Ri(α) as the nonreactive internal resistance of the motor.

In this case, a different number of coils are connected in series depending on the position of the commutator. At the same time, two of these series circuits of coils are connected in parallel with one another. Depending on the angular position, two segments of the commutator can be jointly short-circuited by one brush. The change between this short-circuiting of the two segments and the absence of a short-circuit depending on the rotational angle of the commutator can lead to ripple in the drive current Iₜₒₜ, the ripple also being dependent—as described—on the winding pitch and other design parameters of the motor.

Incorporated by reference herein in their entirety are Germany priority application No. 20 2005 011 333.6, filed Jul. 15, 2005, and its certified English language translation, copies of both of which documents are filed herewith.

What is claimed is:

1. An adjustment system for a motor vehicle, comprising:
a mechanically commutated drive motor; and
a control apparatus; wherein:
the control apparatus has a mechanism for measuring a ripple of a drive current flowing through the mechanically commutated drive motor caused by the mechanical commutation;
the control apparatus is designed to control the drive motor depending on the measured ripple; and
a number of turns of a coil of the mechanically commutated drive motor have a winding pitch corresponding to half the number of slots of the mechanically commutated drive motor reduced by two.

2. An adjustment system for a motor vehicle according to claim 1, wherein the mechanically commutated drive motor comprises ten slots and the number of turns comprises a winding pitch of three.

3. An adjustment system for a motor vehicle according to claim 1, wherein at least one of the number of turns of the coil of the mechanically commutated drive motor has a winding pitch that is different from at least one other turn.

4. An adjustment system for a motor vehicle according to claim 2, wherein at least one of the number of turns of the coil of the mechanically commutated drive motor has a winding pitch that is different from at least one other turn.

5. An adjustment system for a motor vehicle according to claim 3, wherein at least two coils of the drive motor have the at least one turn and the other turn with different winding pitches.

6. An adjustment system for a motor vehicle according to claim 3, wherein:
the turns with the different winding pitches produce a characteristic signal of the ripple that is associated with at least one selected from the group consisting of a motor revolution and an angle of motor revolution; and
the control apparatus is designed to detect the characteristic signal and to correct an adjustment position and/or an adjustment speed of a part to be adjusted depending on the detection.

7. An adjustment system for a motor vehicle according to claim 6, in which the control apparatus is designed to recognize a pattern of the characteristic signal within the ripple.

8. An adjustment system for a motor vehicle, according to claim 1, wherein slots in a rotor of the mechanically commutated drive motor are skewed.

9. An adjustment system for a motor vehicle according to claim 8, in which the mechanically commutated drive motor comprises eight slots and coils with a winding pitch of three.

10. An adjustment system for a motor vehicle according to claim 8, in which the skewing of the slots is restricted to an axial area.

11. An adjustment for a motor vehicle according to claim 10, in which the axial area comprises at least half the length of the slots.

12. An adjustment system for a motor vehicle according to claim 1, in which the control apparatus is set up to determine, depending on the measured ripple, at least one of the group consisting of a position and a speed of a part to be adjusted depending on the measured ripple.

13. An adjustment system for a motor vehicle according to claim 2, in which the control apparatus is set up to determine, depending on the measured ripple, at least one of the group consisting of a position and a speed of a part to be adjusted depending on the measured ripple.

14. An adjustment system for a motor vehicle according to claim 3, in which the control apparatus is set up to determine, depending on the measured ripple, at least one of the group consisting of a position and a speed of a part to be adjusted depending on the measured ripple.

15. A method for adjusting a part of a motor vehicle, the method comprising the steps of:
providing an adjustment system comprising:
a mechanically commutated drive motor having a plurality of turns of a coil and a plurality of slots, the plurality of turns having a winding pitch corresponding to half the number of slots, reduced by two; and
a control apparatus having a mechanism for measuring a ripple of a drive current flowing through the mechanically commutated drive motor caused by the mechanical commutation, the control apparatus further being designed to control the drive motor depending on the measured ripple; and
using the adjustment system to adjust the part.

16. A method for adjusting a part of a motor vehicle according to claim 15, wherein the part comprises a window.

17. A method for adjusting a part according to claim 15, wherein the part comprises an an adjustable part of a seat.

18. A method for adjusting a motor vehicle according to claim 15, wherein the part comprises a swing door.

19. A method for adjusting a motor vehicle according to claim 15, wherein the part comprises a sliding door.

20. A method for adjusting a motor vehicle according to claim 15, wherein the part comprises a trunk lid.

21. A method for adjusting a motor vehicle according to claim 15, wherein the part comprises a tailgate.
